(19) United States
(12) Patent Application Publication
(10) Pub. No.: US 2014/0065987 A1
(43) Pub. Date: Mar. 6, 2014

(54) Generation and Reception of Inverse Circular Polarized Waves

(71) Applicant: Nigel Iain Stuart Macrae, Las Vegas, NV (US)

(72) Inventor: Nigel Iain Stuart Macrae, Las Vegas, NV (US)

(21) Appl. No.: 13/598,058

(22) Filed: Aug. 29, 2012

(51) Int. Cl. H04B 1/02

(52) U.S. Cl. CPC H04B 1/02
USPC 455/110

(57) ABSTRACT

A method is disclosed to generate inverse circular waves in opposite circular polarities. A method is disclosed to receive circular polarity signals in the presence of inverse interfering linear signals.

### BACKGROUND OF THE INVENTION

The method and system disclosed herein, in general, relates to information communication. More particularly, the method and system disclosed herein relates to communicating multiple channels of distinct data, simultaneously, over a single frequency using multiple linear and circular polarized signals.

Normally, no more than two signals on the same frequency can be transmitted simultaneously along the same or proximate path, each occupying one of two either linear or circular orthogonal polarizations. Earlier patents by this same applicant, U.S. Pat. No. 7,590,191 B1, and U.S. Pat. No. 7,957,425 as well as U.S. application Ser. No. 13/237,846 have described methods to increase capacity of transmitted electromagnetic signals by using a combination of circularly and linearly polarized signals.

In U.S. Pat. No. 7,957,425 in one embodiment a method is described in which two inverse circular signals are transmitted orthogonally to each other, i.e., in right and left hand circular polarities respectively. Simultaneously, two distinct linear signals are transmitted on the same frequency in horizontal and vertical linear polarities. The result is the transmission of three distinct signals on the same frequency simultaneously. This present disclosure relates to the method the inverse circular signals are generated and received in the most common design for circular polarizers and receivers.

In the most common polarizer design for circular signals, two dipoles or linear emitters at ninety degrees rotation from each other, ie, orthogonal to each other, transmit the same signal except the signal in one dipole is advanced by 90 degrees or ¼ wavelength or alternatively in the opposite polarity one dipole is delayed 90 degrees or ¼ wavelength. In the right hand polarization one copy of the wave is advanced 90 degrees over the other. The right hand circular signal is defined by COS(kx−wt)H+SIN (kx−wt)V where H and V are orthogonal vectors. The general form of the left hand circular emission (LHC) is defined as COS(kx−wt)H−SIN(kx−wt)V where one copy of the same signal is delayed 90 degrees over the other. The amplitude in both copies are the same forming a circular signal once transmitted.

When generated by orthogonal dipoles, generation of precisely inverse signals in opposite circular polarities requires unique methods disclosed in this application. This application discloses a method of generating inverse circular electromagnetic waves in opposite circular polarities, right and left hand circular, so that they are exactly inverse and cancel upon summation. It also discloses a method of receiving inverse circular polarized signals so that interfering linear signals will cancel.

In an alternative embodiment disclosed in earlier patent applications, two inverse linear signals are transmitted in two orthogonal linear polarities and two distinct circular signals are transmitted in right and left circular polarities respectively for a total of three unique signals. This disclosure also covers a method of receiving two unique circular signals, RHC and LHC, with interfering inverse linear signals so that the interfering linear signals cancel.

In another embodiment, U.S. patent application Ser. No. 13/237,846 discloses a method for transmitting four signals on the same frequency by transmitting two orthogonal and inverse linear signals containing a first data signal at one rotation, and transmitting a second unique data signal on two orthogonal and inverse linear signals at a rotation 45 degrees from the first two inverse linear signals. Data signals three and four are transmitted in right and left hand circular polarizations on the same frequencies. The method disclosed below for generating and receiving circular polarity signals applies to this embodiment as well.

A basic principle of electromagnetic waves is the principle of linear superposition: “when two or more waves are present simultaneously at the same place the resultant wave is the sum of the individual waves.”

Physics 3^{rd} Edition by Cutnell/Johnson, Wiley and Sons, 1995. ISBN 0-471-59773-2, page 521.

“Inverse signals” are two same signals that are exactly 180 degrees out of phase so that when two inverse signals of the same amplitude are combined they sum to zero power, canceling each other.

As used herein, the term “feed horn” or “feed” refers to an apparatus used to transmit polarized electromagnetic signals and/or receive electromagnetic signals. The feed horn typically includes at least one emitter if used to transmit signals and may include structures to shape and filter the transmit signal. It may also include a way to separate the transmitted signal from the receive signal and direct the receive signal into a receive element and the transmitted signal into a transmit antenna. A common design for a circular polarity feed would include two dipole emitters orthogonal to each other. Each emitter transmits the same signal at the same level except that the signal in one dipole is advanced or delayed 90 degrees from the other in order to establish the circular polarized signal. A receive feed is used to receive polarized electromagnetic signals.

As used herein, “data signal” refers to an electromagnetic signal modulated to carry information of any kind. “Information signal” and “data signal” both mean an electromagnetic signal that contains encoded information to be communicated.

A “frequency band” is a contiguous set of frequencies with a center frequency and multiple side frequencies. Two signals of the “same frequency” means that at least one of the frequencies of the frequency band used to transmit a data signal is the same for both signals, i.e., that at least part of the band of frequencies overlaps. Both data signals can occupy the same band or partially overlapping bands. The data signals can convey digital or analog information.

The ‘transmit axis’ is the line between a transmitting antenna and a corresponding receive antenna.

Electromagnetic waves do not interact with each other when transmitted through a non-absorbing media such as space. Horizontal and vertical linearly polarized data signals do not modify each other once transmitted and pass through space without mutual interference. Right and left circular signals polarized data signals do not modify each other once transmitted and pass through space without mutual interference. The disclosed method below can be used wherever electromagnetic signals can be polarized.

### SUMMARY OF THE INVENTION

This summary is provided to introduce a selection of concepts in a simplified form that are further described in the detailed description of the invention.

A common design of a circular feed consists of two linear dipole emitters orthogonal to each other. In the case of right circular transmissions, both dipoles emit the same signal except that one copy fed into one dipole is advanced 90 degrees form the other, and in the case of the left hand circular feed, one copy fed into one dipole is delayed 90 degrees from the other.

In order for two electromagnetic waves to cancel upon summation they must be inverse to each other, i.e., 180 degrees out of phase, and the amplitudes must be the same. For a RHC wave defined as COS(kx−wt)H+SIN(kx−wt)V the inverse LHC signal needs to take the form COS(kx−wt+Θ)H−SIN(kx−wt+Θ)V where Θ is the phase relationship between the first wave and the second wave, and H and V are orthogonal vectors both perpendicular to the axis of transmission. Also, the sum of the amplitudes of left hand signal and the right hand signal must equal zero at all times to be two oposite polaity signals that are inverse inverse.

This means that for two waves in two circular polarities to cancel the following equation must sum to zero

COS(kx−wt)H+SIN(kx−wt)V+COS(kx−wt+Θ)H−SIN(kx−wt+Θ)V=0

One of the important advantages of circular signals over linear signals is that the rotation of the feed around the transmit axis does not influence the polarization. It is unnecessary to align a receive feed with a transmit feed around the transmit axis. This is unlike polarized linear signals where the transmit linear feed needs to be aligned to the receive antenna feed otherwise the opposite pole signal will interfere.

In this disclosure the establishment of a inverse signals requires a precise alignment of the two transmit circular feeds, RHC and LHC. The feeds have to have a 90 degree rotation around the transmit axis from each other. This does not affect the polarization but does affect the establishment of inverse signals. The H vector of one feed must align with the V vector of the opposite polarity feed. This rotation is represented in the equations by shifting the right and left vectors 90 degrees. In this example, the RHC polarity carries signal S1 and the LHC feed caries S2. The S2 signal becomes COS(kx−wt+Θ)V−SIN(kx−wt+Θ)H. In addition, one of the two circular signals needs to be advanced or delayed 90 degrees, ie, phase changed 90 degrees. With the additional of a 90 degree phase change, the S2 signal after the rotation and phase shift is represented by

COS(kx−wt+90°)V−SIN(kx−wt+90°)H.

This is equal to: −SIN(kx−wt)V−COS(kx−wt)H

Adding the equation for the first signal S1 to the phase shifted S2, the right and left polarity signals, we get

COS(kx−wt)H+SIN(kx−wt)V−SIN(kx−wt)V−COS(kx−wt)H

Evaluating this equation we see that the left and right signals are inverse and the sum is always zero:

COS(kx−wt)H+SIN(kx−wt)V+COS(kx−wt+90°)H−SIN(kx−wt+90°)V=COS(kx−wt)H+SIN(kx−wt)V−COS(kx−wt)H−SIN(kx−wt)V=0.

The fact the two waves sum to zero means they cancel when combined.

This method of generating an inverse circular wave in the opposite circular polarity requires the following: 1) the rotation of one of the two feeds 90 degrees in relationship to the other and 2) advancing or delaying one of the two signals, S1 or S2, 90 degrees in relationship to the other.

At reception, since the receive feed design shifts part of the LHC signal 90 degrees forward or delays half of the RHC 90 degrees, it is only necessary to add another plus or minus 90 degree phase shift to the RHC, or alternatively LHC, signal to reach a full 180 degree phase shift for one of the two circular signals. This inverts one of the two already inverted circular signals so that there is a zero degree phase relationship between the right and left received circular signals. When summed the two circular signals match and constructively add. Any interfering linear signals have been received in both circular ports and their phase relationship is now 180° out of phase so they destructively cancel.

In a different embodiment, two inverse linear signals are sent orthogonally to each other and simultaneously with two distinct and unique circular polarity signals. Since the circular receive poles add or subtract a phase delay to the received signal depending on the right or left circular polarity, a phase delay is simultaneously added to the received linear signals. This phase delay varies with the rotation of the linear transmit feed. In order for the linear signals to cancel out in the circular received feed, the method described herein uses two circular feeds, summing the output of the two feeds, or one feed with combiners and splitters that performs the same functions as two summed feeds. These feeds are rotated 90 degrees around the transmit axis from each other. When the received signals from the two same polarity circular receive feeds are added in phase, the inverse linear signals cancel and the circular signals sum, reducing interference from the linear signals.

### BRIEF DESCRIPTION OF THE DRAWINGS

FIG. 1 illustrates the phase relationships between dipoles in the right and left hand circular transmit feeds. Each dipole is represented by a straight line.

FIG. 2 illustrates a 90 degree rotation around the transmit axis of the RHC transmit feed compared to the LHC feed.

FIG. 3 illustrates the addition of a ninety degree phase change to the RHC signal at transmission.

FIG. 4 illustrates the phase changes added by a circular receive port of an antenna to the signals received in the dipoles.

FIG. 5 illustrates receiving a same signal in two RHC feeds at a 90 degree rotation to each other. The output of said feeds are summed.

FIG. 6 illustrates the reception of signals in two circular feeds of the same polarity along with the alignment of the interfering inverse linear signals.

### DETAILED DESCRIPTION OF THE INVENTION

Multiple data signals conveying first data, second data, third data and fourth data are provided. Each data signal is a stream of information, analog or digital, encoded by any of many known means onto a transmit carrier of the selected transmit frequency. All three data signals are of the same frequency. The first data signal conveys the first data, the second data signal conveys the second data, the third data signal convey the third data, and the fourth data signal conveys the fourth data.

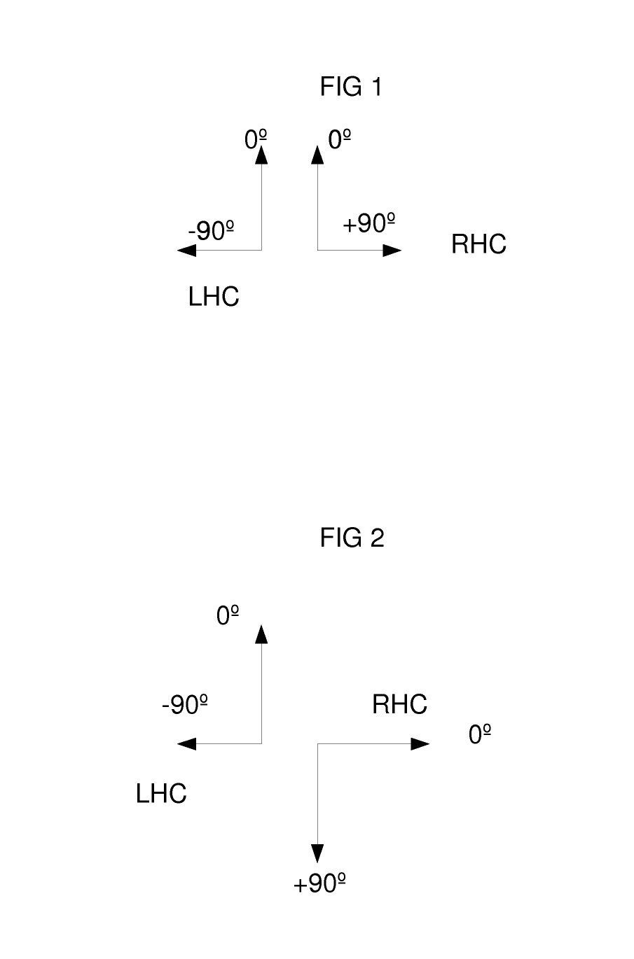

In a common transmit feed design a right hand circular transmit feed contains of two orthogonal linear dipoles or emitters, one phase advanced 90 degrees from the other, and a left hand circular feed contains two orthogonal linear dipoles one phase delayed 90 degrees from the other thus establishing right and left circular transmissions. This method of generating circularly polarized signals results in a phase relationship between the two signals, right and left, that is on average 90 degrees apart. In order to establish a 180 degree phase relationship between the two signals it is necessary to add another 90 degree phase shift to one of the two signals before transmission, as demonstrated below. The phase and rotation of the same signal is controlled to create inverse signals in opposite poles. The FIGS. 1-3 below show the creation of inverse circular signals in opposite circular polarities. A same signal is split and applied in equal amplitudes to the dipoles, designated by H and V, of each polarity.

FIG. 1 shows the right and left circular polarities and phase relationships. The horizontal component precedes the vertical component by 90° in the RHC feed and the horizontal component lags the vertical by 90° in the LHC feed. The H and V lines represent the two dipoles or emitters used to generate the circular signal.

The exact rotation of the feeds relative to each other does not affect the polarization. However, to establish inverse circularly polarized signals in the two orthogonal polarizations the feeds need to be rotated in relationship to each other. FIG. 2 shows a rotation of the RHC feed by 90 degrees clockwise. This is a required step in the creation of inverse circular signals. The rotation of the two feeds in relationship to each other is critical.

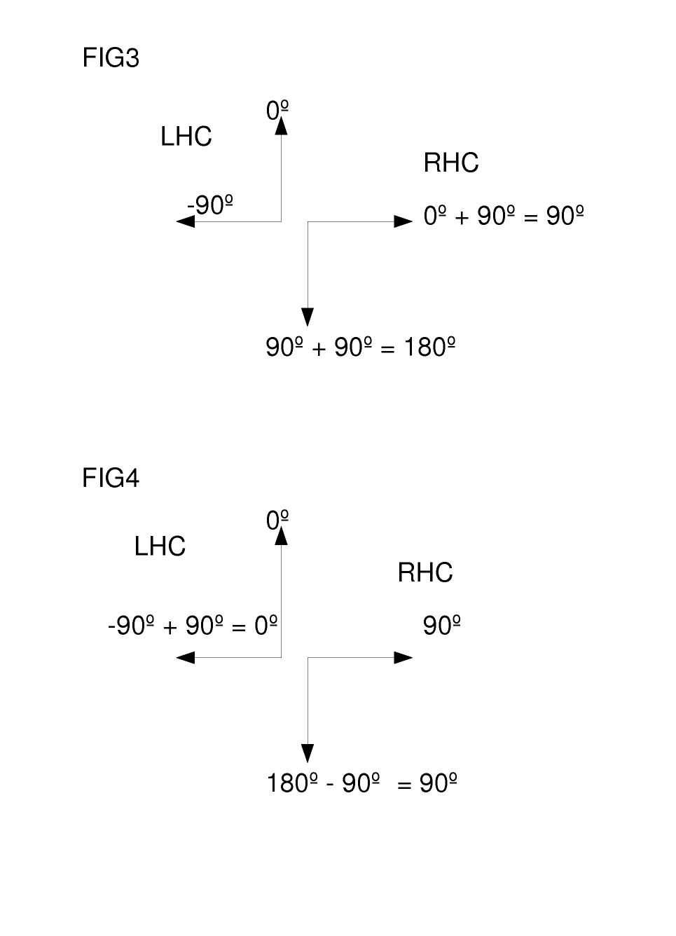

FIG. 3 shows the addition of a 90 degree phase change of the RHC signal. The addition of the 90° phase change is easiest to perform prior to the splitter dividing the signal into vertical and horizontal components. Either the RHC signal needs to be advanced 90 degrees or the LHC needs to be delayed 90 degrees to establish inverse signals.

By observing the components in the above figure it can be seen that the two horizontal components of the two circular signals are always exactly 180 degrees out of phase and the two vertical components are exactly 180 degrees out of phase hence inverse signals are created in the two circular polarities. When the inverse circular signals combine they cancel. Since the signals are of equal amplitude and exactly inverse they cancel.

FIG. 4 shows the phase changes added by the receive ports of the antenna. The received RHC signal is 90 degrees in front of the LHC signal at the output of the receive feed.

It is only necessary to add a 90 degree phase shift to either the RHC signal or the LHC signal to reach a full 180 degree phase shift for one of the two received circular signals. This inverts one of the two already inverted signals so that there is a zero degree phase relationship between the two opposite polarity received circular signals. When summed the two circular signals match and constructively add. Any interfering linear signals have been received in both circular ports and their phase relationship is now 180° out of phase so they destructively cancel. This allows two distinct and orthogonal linear signals to be transmitted on the same frequency and the same or proximate path as the inverse circular polarized signals.

To look at the interfering linear signals received in the circular receive feed, the power of an off axis linear signal received in a linear dipole is represented by A*cos² Θ, where Θ is the angle between the rotation of the transmitted linear signal and the rotation of the receive dipole and A is the amplitude. This is known as the polarization loss factor (PLF).

The equation representing the resulting amplitude of the sum of multiple same sine waves received at different phase angles is

Y=A sin x+B sin(x+P2)+C sin(x+P3) . . .

where P2 and P3 represent the phase angles of the second and third waves to the first and A, B and C represent the amplitudes of the corresponding waves.

Combining the two equations, the sum of the RHC and LHC received signals, after the additional 90° phase shift to the RH signal, is represented by

Y=cos² Θ sin x+cos²(90−Θ)sin(x+90°)+(received in left hand polarity)

cos²(90−Θ)sin(x−90°)+cos² Θ sin(x−180°)(received in right hand polarity plus 90° offset in phase)

Where Θ is the angle between the interfering linear signal and one of the two dipoles and 90−Θ is the angle between the interfering linear signal and the other dipole. The terms cancel:

$$\begin{matrix}Y = {cos}^{2} Θ sin x + {cos}^{2} ( 90 - Θ ) cos x - {cos}^{2} ( 90 - Θ ) cos x - {cos}^{2} Θ sin x \\ = {cos}^{2} Θ sin x + {sin}^{2} Θ cos x - {sin}^{2} Θ cos x - {cos}^{2} Θ sin x \\ = 0\end{matrix}$$

After phase shifting of one of the right hand or left hand received signals by 90 degrees and summation the resulting amplitude of any interfering linear signal is zero. Consequently, any linear signal cancels upon summation of the two circular signals.

In another configuration, two inverse linear signals are transmitted orthogonally to each other. Simultaneously two distinct circular signals are transmitted in the two circular polarities, RHC and LHC. Because the circular receive feeds add or subtract a 90 degree phase to part of the signal, the interfering linear signals are also advanced or delayed. The amount of the delay depends on the rotation of the linear feed in relationship to the phase changed dipole in the receive feed. A method to cancel the linear receive signals received by the circular feeds is disclosed. Basically, two feeds are used, or a single feed acting like two feeds. To receive, for example, the LHC circular signal, two LHC receive feeds are used. One is rotated precisely 90 degrees form the other, meaning the dipoles are rotated 90 degrees. The outputs of the two feeds are summed. The interfering linear signals cancel and the two LHC signals from the two feeds sum.

FIG. 5 shows the relationship of the two receive feeds. The horizontal of 501 is phase delayed 90 degrees by the feed. The horizontal of 502 is also phase delayed 90 degrees. The two dipoles of 501 are summed to output the transmitted RHC signal plus interfering linear signals. The two dipoles of 502 are summed to obtain the same RHC signal plus interfering linear signals. The outputs of 501 and 502 are summed. The RHC is increased in strength while the inverse linear interfering signals cancel.

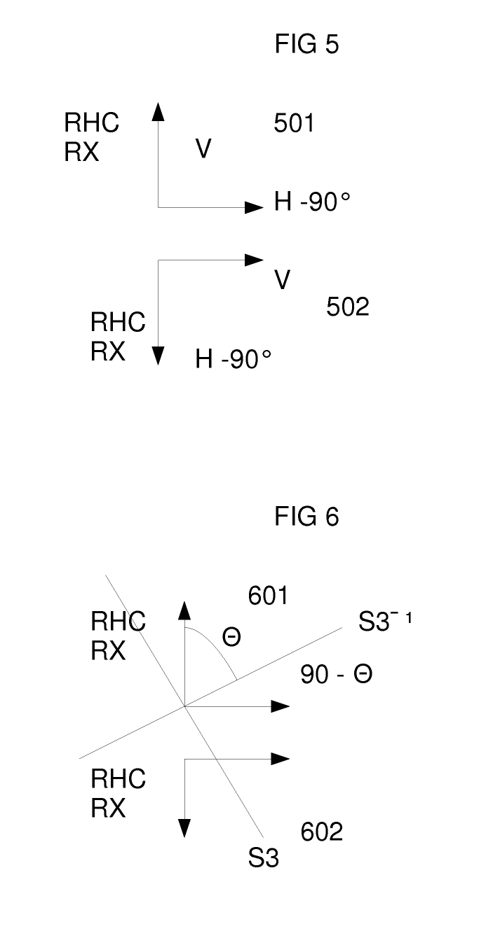

FIG. 6 shows the same dipoles as FIG. 5, however, it also shows interfering and inverse orthogonal inverse linear signals S3 and S3⁻¹.

Mathematically, where S1 and S1⁻¹ are the two inverse linear signals, the amplitudes of the interfering linear signals are represented by

in the horizontal dipole of feed 601: S1 cos²(90−Θ)sin(x+90)+S1⁻¹ cos² Θ sin(x+90)

in the vertical dipole of feed 601: S1 cos² Θ sin x+S1⁻¹ cos²(90−Θ)sin x

in the vertical dipole of feed 602: S1 cos² Θ sin(x+90)+S1⁻¹ cos²(90−Θ)sin(x+90)

in the horizontal dipole of feed 602 S1 cos²(90−Θ)sin x+S1⁻¹ cos² Θ sin x

When summed the terms cancel

S1 cos²(90−Θ)sin(x+90)−S1 cos² Θ sin(x+90)+S1 cos² Θ sin x−cos²(90−Θ)sin x+S1 cos² Θ sin(x+90)−S1 cos²(90−Θ)sin(x+90)+S1 cos²(90−Θ)sin x−S1 cos² Θ sin x=0

This shows that the interfering inverse linear signals sum to zero when the output of the two rotated 90 degrees to each other feeds are summed in phase.

Below shows what happens to the two right hand circular signals at summation: The sum of the two received circular signals can be represented by

$$cos x ( in Horizontal ) + sin x ( in V ) + cos x ( in V ) + sin x ( in H ) = cos x + cos ( x + 90 ) + sin x + sin ( x + 90 ) = 2 sin ( x + 90 ) .$$

In other words, the two RHC signals received in the two RHC receive feeds sum to the original wave advanced 90 degrees with twice the power. Similarly, for receiving LHC signals two LHC feeds are used that are rotated precisely 90 degrees from each other and the outputs are summed to obtain the desired circularly polarized signal while reducing interference from the inverse linearly polarized signals.

In conclusion, summing the output of two of the same polarity feeds, rotated precisely 90 degrees from each other, results in cancellation of the inverse orthogonal linear signals S3 and S3⁻¹ and a doubling of the desired LHC or RHC signals.

The two feeds can actually be one feed where the signal received in the horizontal dipole is split and the signal received in the vertical dipole is split, one copy of each is advanced 90 degrees and the four signals are summed. The output is represented as follows, with H and V being the output of the two dipoles:

H+(V+90°)+V+(H+90°)=desired signal.

This is equivalent to the summation of the output of two same polarity feeds, one rotated 90 degrees from the other.

I claim:

1. a method of generating inverse circular polarized electromagnetic signals consisting of A) aligning a second and orthogonal circular polarity feed at a 90 degree rotation around the transmit axis from a first circular polarity feed B) splitting a same data signal into two copies C) transmitting a first copy in the first circular polarity feed D) adding a 90 degree phase shift to the second copy and E) transmitting the second copy in said second circular polarity feed
Whereby two signals exactly inverse to each other are created and transmitted.

2. the method of claim 1 used in conjunction with the transmission of linear signals on the same frequency.

3. the method of claim 1 whereby after reception the signal received in a second polarity receive feed is phase shifted 90 degrees and summed with the signal received in a first polarity receive feed.

4. a method of receiving two opposite polarity circular signals consisting of receiving the two signals in two opposite circular polarity feeds, and 2) adding or subtracting a 90 degree phase shift to one of the two received signals and 3) combining the two resultant received signals thereby increasing the strength of the selected circular signals while reducing interference by linear polarized signals.

5. the method of claim 4 used with the simultaneous transmission of linear signals on the same frequency along a same or proximate path.

6. a method of receiving circular polarity transmissions consisting of receiving a signal in a first of two orthogonal circular polarity receive feeds, receiving the same polarity signal in the second of same polarity receive feeds which has been rotated at 90 degrees around the transmit axis from said first feed, and c) summing the outputs of the two feeds in phase whereby said same polarity circular signal sum and interfering linear signals are reduced.

7. the method of claim 6 where instead of two same polarity circular feeds a single feed is used consisting of two orthogonal dipoles, the outputs of said dipoles are represented by H and V, and where the outputs of said dipoles are summed as follows H+(V+90°)+V+(H+90°), or in the opposite circular polarity H+(V−90°)+V+(H−90°).

8. The method of claim 6 including the prior transmission of two distinct circular signals and the prior transmission of two orthogonal linear polarity signals that are inverse to each other; all of which are on the same frequency.
